(19) United States
(12) Patent Application Publication
(10) Pub. No.: US 2018/0085192 A1
(43) Pub. Date: Mar. 29, 2018

(54) Flexibly resilient periotome

(71) Applicants: Michael E. Lasner, Mt Kisco, NY (US); Jeffrey I. Lasner, Purchase, NY (US)

(72) Inventors: Michael E. Lasner, Mt Kisco, NY (US); Jeffrey I. Lasner, Purchase, NY (US)

(21) Appl. No.: 15/330,503

(22) Filed: Sep. 28, 2016

(51) Int. Cl. A61C 3/14

(52) U.S. Cl. CPC A61C 3/14

(57) ABSTRACT

A novel periotome is disclosed for manually cutting periodontal ligaments during a tooth extraction procedure. The periotome carries end tools manufactured from flexible medical grade materials, usually stainless steel. The end tools have flexible cutting blades with serrated edges and use flattened yieldable surfaces to relieve tool tip stresses which occur during exodontic procedures.

### CROSS REFERENCE TO RELATED APPLICATIONS

The present application claims the priority of U.S. Provisional Patent Application Ser. No. 62/284,409, filed Sep. 29,2015, entitled “FLEXIBLY RESILIENT PERIOTOME WITH SERRATIONS”.

### BACKGROUND OF THE INVENTION

### 1. Field of the Invention

The present invention relates to exodontia, the branch of dental surgery concerned with the removal of teeth and, specifically, to instruments called periotomes which are used to sever periodontal ligaments which are multitudinous fibrous ligaments attaching the root of a tooth to a jawbone.

### 2. Description of the Prior Art

A tooth is held in its socket by the periodontal ligaments. Extraction of a tooth requires the severing or parting of the periodontal ligaments surrounding the tooth. Historically this is accomplished using dental “elevators”—essentially, pointed levers to pry and push a tooth up so that it can be grasped using a dental forceps to “luxate” or dislocate a tooth from its socket by rocking it back and forth. The dental clinician is required to rock the tooth in many directions in an effort to widen the socket and break the hold of the ligaments. Because periodontal ligaments are very strong, relatively large forces are required to separate the tooth from its socket and therefore dental elevators are relatively heavy tools comprised of thicker metal components when compared to other dental instruments. U.S. Pat. No. 2,366,672 (1948) issued to Montelius is representative of common dental elevating tools. As a consequence of the substantial mechanical forces introduced during the lifting and luxating procedure, unanticipated breakage or damage to surrounding tissue may accompany tooth extraction which may require additional surgical repair and restorative procedures.

To mitigate the violence associated with luxating techniques which are frequently accompanied by iatrogenic injury, periotomes were developed. Periotomes are thin bladed instruments which can be inserted into the periodontal ligament space surrounding the tooth. When forcibly inserted the metal point of the instrument will cause the periodontal fibers to stretch beyond their elastic limits causing them to fracture and thus create a separation space between the fibers on the surface of the root and the fractured ligamental remnants remaining in the socket of the tooth. A periotome of this kind is taught by Robert in U.S. Pat. No. 6,309,219 B1 (2001).

In use, the clinician plunges the tip of the periotome into the periodontal fibers surrounding the tooth moving the tip of the instrument up and down in a circular motion while moving the instrument around the perimeter of the tooth as closely as his or her dexterity will allow. Typically, the perimeter region surrounding the root of a tooth is curved because the socket in which the tooth is embedded is elliptically shaped. As a result of the curvature and complicated geometry surrounding the tooth periodontal ligaments are not always completely severed with adjacent plunges and circular movement. Therefore the clinician must “walk” the periotome around the perimeter of the tooth and root until adequate separation occurs. However conventional periotomes are manufactured from very thin, hard and brittle materials which readily cut ligamental tissue but have limited ability to bend or flex. If the elastic limit of the tip of an instrument is exceeded during these maneuvers then the component tool tip shatters or breaks as a result of the manually induced force. The fractured tool tip may become lodged in a tooth socket or be thrown to the back of a patient's throat or cause some other unforeseen injury requiring additional and often challenging remedial procedures.

To avoid the undesirable consequences that may arise from a broken or fractured periotome, or from broken pieces of similar devices associated with tooth removal during an extraction procedure, it is a primary object of this invention to provide an improved periotome made from more flexible component materials and configured and fabricated to greatly improve resilience to frequent mechanical flexing or bending.

### SUMMARY OF THE PRESENT INVENTION

The present invention discloses a novel and non-obvious periotome made from medical grade materials typically flexible grades of stainless steel. End tools of the inventive periotome are formed from round stainless steel wire extending linearly outward along the major long axis of a central handle. The end tools are tapered and terminate in offset blade end portions. Specific areas in the offset end portions allow increased flexibility as the wire is flattened and thinner in those regions. The flattened regions are more flexibly yieldable as bending forces occurring in reaction to placement of the periotome tip are developed over a wider area than with the round diameter. By varying the location and extent of the flattened region on specific parts of the end portions, different degrees of flexibility and hence stress accommodation are obtainable. The periotome blade becomes much more tolerant to repeated flexing and transaxial bending moments developed from the reaction forces which occur when the periotome blade is being utilized. The blade ends of conventional periotomes are normally brittle and rigid resulting in many fracture failures. Applicant's inventive periotome has a more flexible end blade which in conjunction with the special flattened stress reducing area allows the surgeon using the flexible blade to manipulate it more easily to conform to various curvatures surrounding the external portion of a tooth and the cementum of the root.

In addition, in the preferred embodiment, one or more edges of the arrowhead-shaped tips of the periotome have serrations to engage the fibers of the periodontal ligaments. The serrations serve to augment the effectiveness of up and down sawing motions employed by the surgeon clinician to break the ligamentous fibers. The serrations cause the fibers to spread out catching individual and small groups of fibers and more easily separating and fracturing them.

### BRIEF DESCRIPTION OF THE DRAWINGS

FIG. 1 is a side elevational perspective view of a preferred embodiment of the invention;

FIG. 2 is an enlarged detail perspective view of the top right end of the inventive instrument shown in FIG. 1;

FIG. 3 is an enlarged detail perspective view of the lower left end of the inventive instrument shown in FIG. 1;

FIG. 4 is an enlarged detail perspective view of the top right end of the inventive instrument shown in FIG. 1 rotated forward and pointed downward.

FIG. 5 is an enlarged detail perspective of the lower left end of the inventive instrument shown in

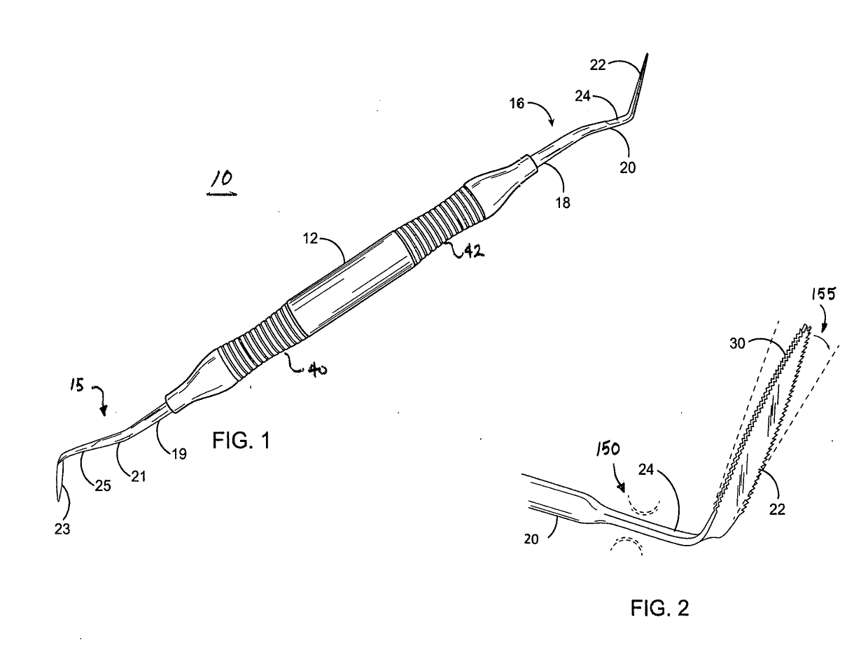

FIG. 1 slightly rotated away along the central long axis of the handle.

### DETAILED DESCRIPTION OF PREFERRED EMBODIMENTS

FIG. 1 illustrates a perspective view of a preferred embodiment of the inventive periotome 10. This example of the inventive periotome 10 comprises a handle 12 having two operative end tools 15 and 16 securely fastened on each end. Each end tool is formed from a single piece of metal, preferably a flexible stainless steel of medical grade. The overall length of the periotome 10 is approximately 180 mm.

Handle 12 occupies the center portion along the major axis of the periotome and is approximately 106 mm in length and approximately 10 mm in maximum diameter. Two regions on the handle 40 and 42 of roughly 20 mm in length are reduced in diameter to approximately 8.8 mm to accommodate preferences of the dental clinician when manipulating the instrument. A series of annular grooves are provided within regions 40 and 42 along the surface of handle 12 to improve finger grip and comfort.

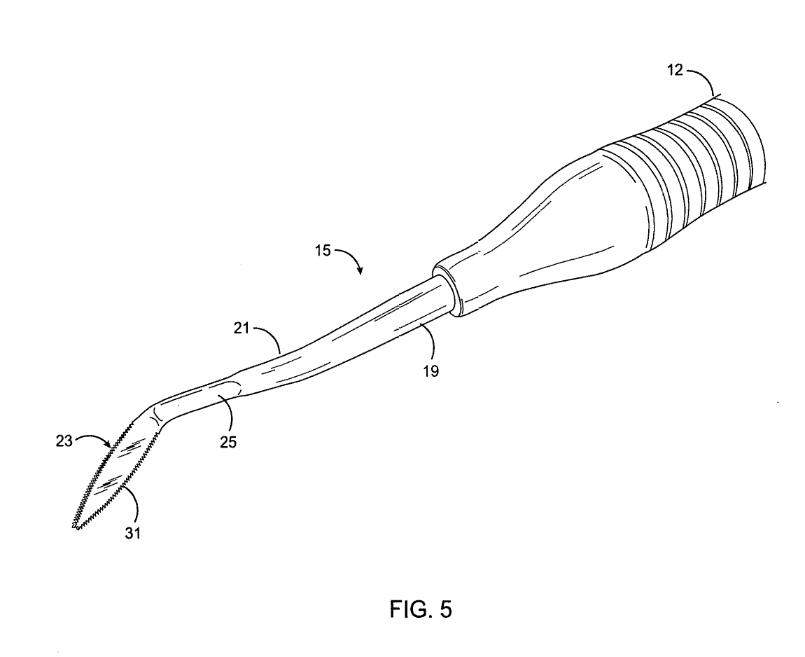

As shown in FIGS. 1, 3 and 4, each individual end tool 15 or 16 can be described as having four sections, namely:

a tool stem section, 18 and 19, respectively, which protrudes outward linearly along a central axis from opposite ends of handle 12;

a tapered offset section, 20 and 21, respective to each end tool;

an offset section 20 having a flattened section 24 and an offset section 21 having flattened section 25, respective to each end tool;

and an offset end blade 22 and an offset end blade 23, respectively, each having arrowhead or spear point shapes and serrations 30 and 31, respectively, on major portions of the perimeters of each blade.

In this preferred embodiment, the end tools are formed from round stainless steel wire of medical grade and coated for additional hardness with titanium nitride. At the handle 12 end the exposed steel wire stem diameter is approximately 3.15 mm.

Tool stem sections 18 and 19 are each approximately 14 mm long. The tool stem sections 18 and 19 taper distal to handle 12 to a diameter of approximately 2.50 mm where each is bent in an offset of approximately 20 degrees from the central axis of the periotome handle 12.

Tapered offset sections 20 and 21 are each approximately 14 mm in overall length measured from the bend where each becomes offset from its respective tool stem section.

However, a portion of offset sections 20 and 21 are formed into flattened sections 24 and 25, respectively.

The diameters of tapered offset sections 20 and 21 are approximately 2.0 mm at the locations where they are formed into flattened sections 24 and 25. Flattened sections 24 and 25 are each approximately 0.7 mm in thickness and 2.26 mm in width.

In the preferred embodiments depicted in the various FIGS., different length flattened areas are shown. The length of flattened section 25 in end tool 15 is approximately 5 mm. The length of flattened section 24 in end tool 16 is approximately 7.5 mm. The longer flattened section in end tool 16 creates a longer lever arm than the corresponding flattened section in end tool 15. As such, and because the tools are made from the same material, end tool 16 is more flexible. It is more flexible in the sense that it is more easily displaced by a similar engaging force or counterforce when in contact with the tooth contours or periodontal ligaments. End tool 15 has a shorter lever arm and will have stiffer characteristics.

The end blades 22 and 23 of the inventive periotome as shown in FIGS. 1-5 have serrations 30 and 31 respectively along their outside perimeters. Each blade is approximately 17 mm long and formed into a flat arrowhead or spear point shape. Each is approximately 2.5 mm across at its widest part tapering to a point which is approximately 1 mm wide. The thickness across the flat surface of each blade is approximately 0.5 mm. Each blade, 22 and 23, is offset from the central handle axis by approximately 40 degrees in the opposite direction from its respective tapered offset sections (20 or 21).

In addition, and perhaps best viewed in FIG. 2, each blade is twisted or rotated approximately 45 degrees from its point of offset to enable the clinician to more easily perform cuts along the perimeter of a tooth.

The serrations along the perimeter of the end blades facilitate the cutting of the periodontal ligamental fibers. In use, the blade of the periotome is inserted into the periodontal ligament space surrounding the external surfaces of the tooth and root. A certain percentage of the ligamental fibers are cut or fractured immediately in the direction the blade is inserted. The serrated edge of the blade stretches and captures additional fibers which fall into the serrated spaces. When the clinician withdraws the blade these additional ligamental fibers are broken. As such the efficiency of the cutting and extraction process is greatly enhanced minimizing damage to surrounding tissue.

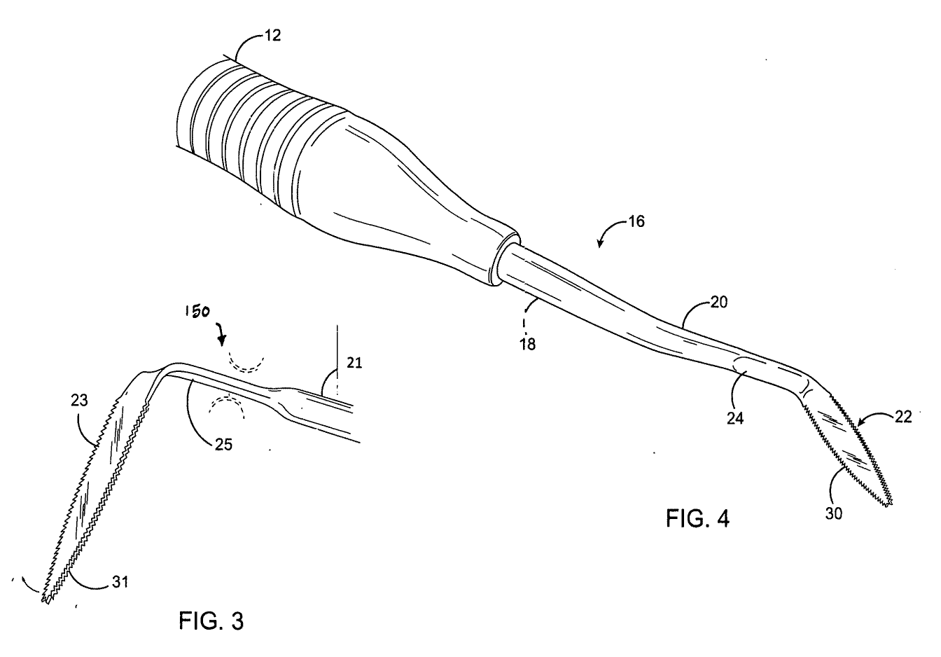

The flexible metallic blade, when directed by the surgeon clinician, will conformably follow the surface of the cementum—the outside of the root of the tooth. The reflected reaction forces from engagement with the periodontal ligaments or the hard surface of the tooth may cause the blade to bend. However, and with specific reference to FIG. 2 and FIG. 3, those forces are deflected by the flexible blade at 155 and by the yieldable offset section 150 of the inventive tool as shown by the graphical indicators in FIGS. 2 and 3. Flattened regions, such as 24 and 25 in FIGS. 1,3,4 and 5 allow for an extensive and varied range of motion in response to manipulation of the blade by the surgeon clinician.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims.

What is claimed:

1. (canceled)

2. (canceled)

3. (canceled)

4. A dental instrument comprising:
a handle having two ends;
a first end tool comprised of a tool stem securely fastened to a first end of said handle,
said tool stem protruding outward linearly along the central major axis of the handle,
said tool stem having a linear tapered section and a tapered offset section bent away from said central major axis distal to said first handle end,
said tapered offset section having a flattened flexibly yieldable section of a first length extending to an end blade angularly offset from the flattened flexibly yieldable section;
a second end tool comprised of a tool stem securely fastened to a second end of said handle,
said tool stem protruding outward linearly along the central major axis of the handle,
said second tool stem having a linear tapered section and a tapered offset section bent away from said central major axis distal to said second handle end,
said tapered offset section having a flattened flexibly yieldable section of a second length extending to an end blade angularly offset from the flattened flexibly yieldable section.

5. A dental instrument according to claim 4 wherein the end blade is comprised of flexible material.

6. A dental instrument according to claim 5 wherein the flexible material is stainless steel.

7. A dental instrument according to claim 4 wherein the flattened flexibly yieldable section may be varied in location and extent thereby providing different degrees of flexibility and stress accommodation.

8. A dental instrument comprising:
a handle having two ends,
a first end tool comprised of a tool stem securely fastened to a first end of said handle,
said tool stem protruding outward linearly approximately 14 mm in length along the central major axis of the handle,
said tool stem having a linear tapered section approximately 14 mm length and a tapered offset section approximately 14 mm in length bent away approximately 20 degrees from said central major axis distal to said first handle end,
said tapered offset section having a flattened flexibly yieldable section of a first length of approximately 5 mm in length, 0.7 mm in thickness and 2.26 mm in width extending to an end blade approximately 17 mm long formed into a flat arrowhead shape which is angularly offset approximately 40 degrees from the plane of the flattened flexibly yieldable section;
a second end tool comprised of a tool stem securely fastened to a second end of said handle,
said tool stem protruding outward linearly approximately 14 mm along the central major axis of the handle,
said second tool stem having a linear tapered section approximately 14mm in length and a tapered offset section approximately 14 mm in length bent away approximately 20 degrees from said central major axis distal to said second handle end,
said tapered offset section having a flattened flexibly yieldable section of a second length of approximately 7.5 mm in length, 0.7 mm in thickness and 2.26 mm in width extending to an end blade approximately 17 mm long formed into a flat arrowhead shape which is angularly offset approximately 40 degrees from the plane of the flattened flexibly yieldable section.

9. A dental instrument according to claim 4 wherein each end blade has serrated edges.

10. A dental instrument according to claim 8 wherein each end blade has serrated edges.
